(19) United States
(12) Patent Application Publication
(10) Pub. No.: US 2005/0021760 A1
(43) Pub. Date: Jan. 27, 2005

(54) PPPoE network system and reconnection method thereof

(76) Inventor: Jin-Won Kim, Paju-city (KR)

Correspondence Address: Robert E. Bushnell;Suite 300, 1522 K Street, N.W., Washington, DC, 20005, US

(21) Appl. No.: 10/772,393

(22) Filed: Feb. 6, 2004

(30) Foreign Application Priority Data
Feb. 12, 2003 (KR) 2003-8925

(51) Int. Cl. G06F 15/16

(52) U.S. Cl. 709/227

(57) ABSTRACT

A PPPoE (Point-to-Point Protocol over Ethernet) network system and connection method thereof. The connection method includes the steps of: if a connection attempt is made, transmitting a PADI (PPPoE Active Discovery Initiation) packet to a plurality of servers by performing a discovery stage; after transmitting the PADI packet, deciding whether a packet being transmitted from a server is transmitted in a session packet in a PPP session stage or a PADO (PPPoE Active Discovery Offer) packet; and if the packet being transmitted from the server is the session packet, terminating connection between a client and an already-connected server by performing a discovery stage for terminating the connection, and then reestablishing the connection by performing a discovery stage for connection. Therefore, even though the connection between the client and the server is unproperly disconnected due to errors on the client side, the connection can be reestablished faster and more effectively.

### CLAIM OF PRIORITY

This application makes reference to, incorporates the same herein, and claims all benefits accruing under 35 U.S.C §119 from an application entitled PPPoE NETWORK SYSTEM AND CONNECTION METHOD THEREOF earlier filed in the Korean Industrial Property Office on Feb. 12, 2003, and there duly assigned Ser. No. 2003-8925 by that Office.

### BACKGROUND OF THE INVENTION

1. Field of the Invention

The present invention relates to PPPoE (Point-to-Point Protocol over Ethernet) network system, and more particularly, to a PPPoE network system and a reconnection method thereof for reconnection between a client and a server.

2. Description of Related Art

PPPoE network system enables many clients using an Ethernet through equipment like modem to be connected to a server in a remote site. That is, the system is used for the purpose of connecting every client in offices or buildings sharing a modem or wireless connection to an Internet. PPPoE protocol, which is regulated by RFC (Request for Comments) 2516, is the combination of PPP (Point-to-Point Protocol) that is typically used in dial-up connection and Ethernet protocol for supporting many clients over a short-distance network.

In accordance with RFC 2516 standards, operation between a client (Host) and a server (Access Concentrator) in the related art PPPoE network system consists of a discovery stage for connecting the client to the server, a PPP session stage which the client connects to a wanted site over Internet and transmits/receives data, and a discovery stage for terminating the connection between the client and the server.

When a client wishes to initiate a PPPoE session, it must first perform discovery to identify the Ethernet MAC address of the peer and establish a PPPoE Session_ID. While PPP defines a peer-to-peer relationship, discovery is inherently a client-server relationship. In the discovery process, the client discovers the server. Based on the network topology, there may be more than one server that the client can communicate with. The discovery stage allows the client to discover all server and then select one. When discovery completes successfully, both the client and the selected server have the information they will use to build their point-to-point connection over Ethernet.

However, the PPPoE network system has a problem in that the connection between the client and the server is often disconnected due to abnormality in the client's device or at the request of a user, in the middle of transmitting and receiving data in the PPP session stage. Then, the user reboots the client's device and attempts reconnection.

At this time, the client tries the discovery stage for reconnection, on the other hand, the server does not really know that its connection to the client has been disconnected, so the server transmits a packet requested by the client or an echo packet while continually holding in the PPP session stage. As a result, the client fails in the reconnection no matter how many times the client tries.

Generally, a server is programmed to recognize no response from the client within a predetermined time in the PPP session stage as disconnection. However, if rebooting the client's device can be done faster than the server recognizes its disconnection to the client, the server cannot recognize its disconnection to the client even though the client's device is rebooted and the client tries to reconnect to the server. Therefore, the client fails in reconnection.

That is, the conventional PPPoE network system is disadvantageous in that when the client's device is abnormal (or out of order) or the connection between the client and the server is disconnected at the user's request, the client often fails in reconnection even though the client reboots the device and attempts the reconnection to the server, and the reconnection to the server is not done fast enough.

### SUMMARY OF THE INVENTION

An object of the invention is to solve at least the above problems and/or disadvantages and to provide at least the advantages described hereinafter.

Accordingly, it is one object of the present invention to provide PPPoE (Point-to-Point Protocol over Ethernet) network system, capable of making connection between a client and a server even when the connection to the server is abnormally disconnected due to an error on the client side.

It is another object of the present invention to provide a connection method of the system.

The foregoing and other objects and advantages are realized by providing a PPPoE network system, including: a plurality of clients; a plurality of modems connected to the plurality of clients through Ethernet lines; a plurality of servers; and a plurality of digital subscriber line access multiplexers for PPP connection between of the plurality of modems and the plurality of servers, the plurality of clients, if a connection is tried, transmitting a PADI (PPPoE Active Discovery Initiation) packet to the plurality of servers to perform a discovery operation for connection, if a session packet transmitted in a PPP session operation is transmitted from an already-connected server, performing a discovery operation for terminating connection between the client and the server and performing a discovery operation for reconnection and transmitting the PADI (PPPoE Active Discovery Initiation) packet (initiation packet), and if a PADO (PPPoE Active Discovery Offer) packet (offer packet) is received from the server capable of providing connection to the client among the plurality of servers, transmitting a PADR (PPPoE Active Discovery Request) packet (request packet) to the server, and receiving a PADS (PPPoE Active Discovery Session-confirmation) packet (confirmation packet) transmitted from the server.

Another aspect of the present invention provides a connection method of PPPoE network system including steps of: if a connection is tried, transmitting a PADI (PPPoE Active Discovery Initiation) packet to a plurality of servers by performing a discovery stage; after transmitting the PADI (PPPoE Active Discovery Initiation) packet, deciding whether a packet transmitted from a server is a session packet transmitted in a PPP session stage or a PADO (PPPoE Active Discovery Offer) packet; and if the packet transmitted from the server is the session packet, terminating connection between a client and an already-connected server by performing a discovery stage for terminating the connection, and then reconnecting to the server by performing a discovery stage for connection.

Preferably, the connection method of PPPoE network system further includes the step of: if the packet transmitted from the server is the PADO (PPPoE Active Discovery Offer) packet, establishing the connection by performing the discovery stage for connection.

The deciding step decides the packet transmitted from the server is the session packet or the PADO (PPPoE Active Discovery Offer) packet, on the basis of the code of the code field in the packet transmitted from the server.

The terminating and reconnecting step includes steps of: extracting a session ID from the session identifier, and when performing the discovery stage for terminating the connection; loading the extracted session ID into a session ID field of a PADT (PPPoE Active Discovery Terminate) packet; and transmitting the PADT (PPPoE Active Discovery Terminate) packet.

The terminating and reconnecting step includes steps of: deciding whether the session packet is a corresponding packet by extracting a client MAC address from the session packet, and if the session packet is the corresponding packet, extracting the session ID from the session packet, when performing the discovery stage for terminating the connection, loading the extracted session ID into a session ID field of a PADT (PPPoE Active Discovery Terminate) packet, and transmitting the PADT (PPPoE Active Discovery Terminate) packet.

The terminating and reestablishing connection step includes steps of: when performing the discovery stage for connection, transmitting a PADI (PPPoE Active Discovery Initiation) packet, deciding whether a PADO (PPPoE Active Discovery Offer) packet is received after transmitting the PADI (PPPoE Active Discovery Initiation) packet, transmitting a PADR (PPPoE Active Discovery Request) packet when the PADO (PPPoE Active Discovery Offer) packet is received, and deciding whether a PADS (PPPoE Active Discovery Session-confirmation) packet is received after the PADR (PPPoE Active Discovery Request) packet is transmitted.

The terminating and reestablishing connection step includes steps of: when performing the discovery stage for connection, transmitting a PADR (PPPoE Active Discovery Request) packet in response to the PADO (PPPoE Active Discovery Offer) packet, and deciding whether a PADS (PPPoE Active Discovery Session-confirmation) packet is received after the PADR (PPPoE Active Discovery Request) packet is transmitted.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram illustrating a representative configuration of an exemplary PPPoE network system;

FIG. 2 is a diagram describing an operation between a client and a server in the PPPoE network system of FIG. 1;

FIG. 3 is a diagram describing a reconnection method between the client and the server in the PPPoE network system of FIG. 1;

FIG. 4 is a diagram describing a reconnection method between a client and a server in PPPoE network system according to the present invention;

FIG. 5 is a flow chart explaining an operation of the client for connection between the client and the server in the PPPoE network system according to the present invention;

FIG. 6 illustrates a PADI (PPPoE Active Discovery Initiation) packet transmitted from the client to the server; and

FIG. 7 illustrates a packet transmitted from the server to the client.

### DETAILED DESCRIPTION OF EXEMPLARY EMBODIMENTS

Reference will now be made in detail to exemplary embodiments of the present invention, which are illustrated in the accompanying drawings.

Before discussing about PPPoE network system and connection method thereof according to the present invention, PPPoE network system and connection method thereof according to the related art will be first explained as follows.

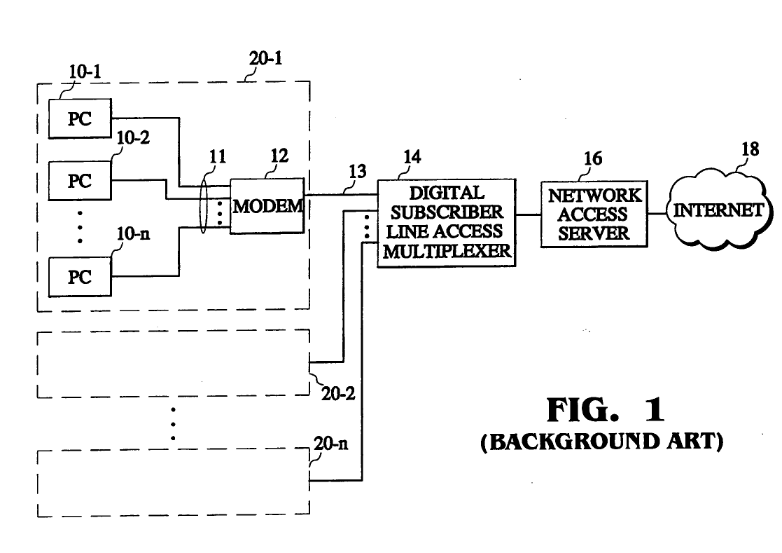

FIG. 1 is a block diagram depicting the configuration of the related art PPPoE network system. As shown in the drawing, the PPPoE network includes short-distance networks 20-1˜20-n equipped with personal computers 10-1˜10-n, and modem 12, digital subscriber line multiplexer 14, network access server 16, and Internet 18.

Each of the personal computers 10-1˜10-n of the short-distance networks 20-1˜20-n and the modem 12 (e.g. ADSL or ISDN) are connected via Ethernet lines 11, and the modem 12 and the digital subscriber line multiplexer 14 are connected to each other through a line 13 (e.g. telephone line).

When the client transmits data through the Ethernet lines 11, the data is to include a PPP frame in an Ethernet frame, and the modem 12 extracts the PPP frame from the Ethernet frame and transmits the PPP frame through the line 13. Also, the modem 12 transmits a PPPoE frame through the Ethernet lines 11, the PPPoE frame is to include the Ethernet frame in a PPP frame transmitted from the digital subscriber line access multiplexer 14 through the line 13.

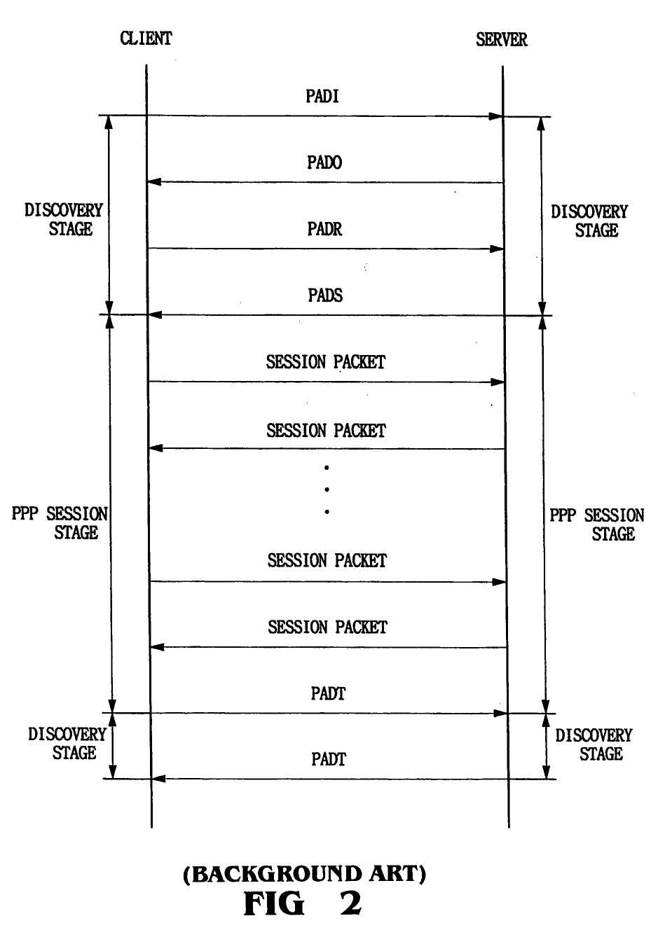

FIG. 2 is a diagram describing an operation between the client and the server in the PPPoE network system of FIG. 1, wherein the operation between the client and the server according to RFC 2516 standards is shown.

In FIG. 2, clients corresponds to users' personal computers 10-1˜10-n of FIG. 1, and the server corresponds to the network access server 16 of FIG. 1.

Referring to FIG. 2, the operation between the client and the server includes a discovery stage for connecting the client to the server, a PPP session stage for transmitting and receiving data through Internet after the connection between the client and the server is complete, and a discovery stage for terminating the connection between the client and the server.

To begin with, the discovery stage for connection is explained below.

The client transmits a PADI (PPPoE Active Discovery Initiation) packet to servers for initiation.

A server, which is capable of providing connection to the client among the servers received the PADI (PPPoE Active Discovery Initiation) packet, transmits the PADO (PPPoE Active Discovery Offer) packet to the client.

After the client receives the PADO (PPPoE Active Discovery Offer) packet, the client transmits a PADR (PPPoE Active Discovery Request) packet to the server, to request connection.

When the server receives the PADR (PPPoE Active Discovery Request) packet from the client, the server transmits a PADS (PPPoE Active Discovery Session-confirmation) packet to the client, to confirm the connection.

In this manner, the connection between the client and the server is complete. Then, the client and the server proceed to the PPP session stage, and transmit and receive data each other.

Lastly, the discovery stage for terminating the connection is explained.

The client transmits a PADT (PPPoE Active Discovery Terminate) packet to the server.

The server sends PADT (PPPoE Active Discovery Terminate) to the client to terminate the session performed in the session stage in response to the PADT (PPPoE Active Discovery Terminate) packet. Accordingly, the client and the server are disconnected from each other.

However, the foregoing PPPoE network system has a disadvantage in that its reconnection is not easy when the disconnection is caused by, for example, an abnormality in the client's device, or at the request of the user in the PPP session stage.

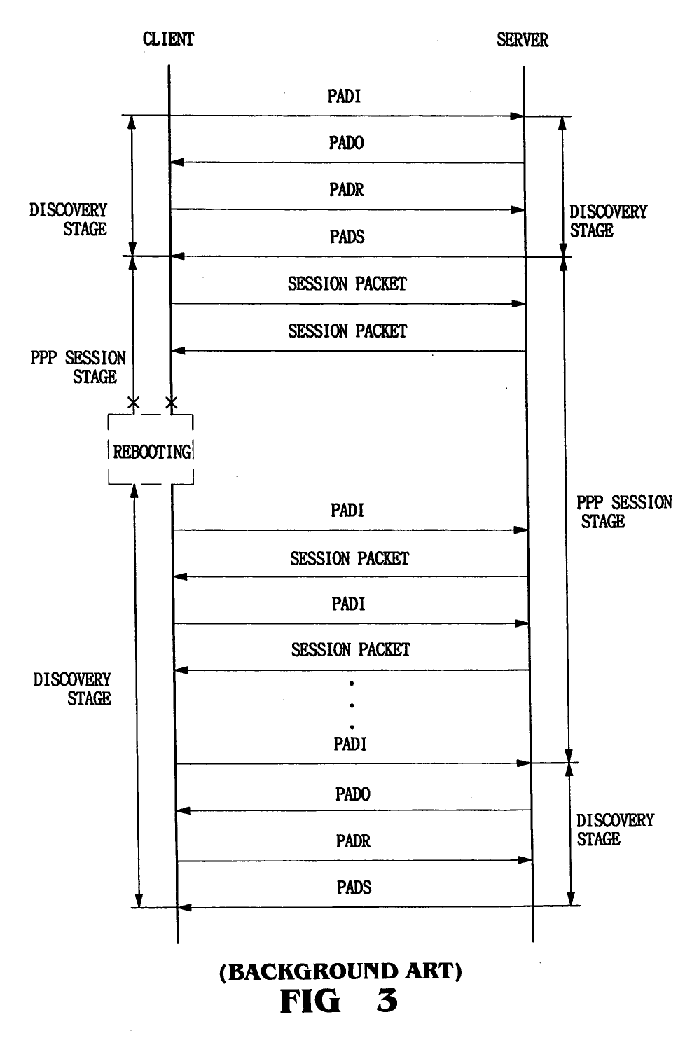

FIG. 3 is a diagram describing a reconnection method between the client and the server of the PPPoE network system of FIG. 1.

Here, the operation in the discovery stage for connection is equal to that of FIG. 2, that is, the server and the client are connected to each other by performing the discovery stage.

The client and the server proceed to the PPP session stage, the connection with the server is disconnected if the client's device is abnormal or the user wants to disconnect while transmitting and receiving a session packet in the PPP session stage. That is, the proper termination procedure of transmitting a PADT (PPPoE Active Discovery Terminate) packet from the client to the server was not followed.

In such case, the user reboots the client's device and tries to establish the reconnection. When the reconnection is tried, the client proceeds to the discovery stage for connection, and transmits the PADI (PPPoE Active Discovery Initiation) packet to the server.

Although the server is supposed to transmit the PADO (PPPoE Active Discovery Offer) packet in response to the PADI (PPPoE Active Discovery Initiation) packet, the already-connected server does not recognize that it is disconnected from the client, because the proper termination procedure was not performed. Then, the server continuously performs the PPP session stage and transmits the PPP session packet.

Of course, generally, the server is programmed to be able to recognize the disconnection if there is no response from the client within a predetermined time during the PPP session stage. It has been recommended in the RFC 2516 that the server occasionally send Echo-Request packets to the client to determine the state of the session. Otherwise, if the client terminates a session without sending a PADT (PPPoE Active Discovery Terminate) packet, the server will not be able to determine that the session has gone away. However, if the client's device is rebooted before the server transmits the Echo-Request packet, and the reconnection after rebooting cannot be made sufficiently fast.

When a client does not receive a PADO packet within a specified amount of time, it should resend it's PADI (PPPoE Active Discovery Initiation) packet and double the waiting period. This is repeated as many times as desired. As a result, the client keeps transmitting the PADI (PPPoE Active Discovery Initiation) packet, and the already-connected server continues transmitting the PPP session packet. After the server transmits the Echo-Request packet and fails to receive a proper response from the client, the server realizes that the client is terminated (disconnected), so it goes to the discovery stage, and then, in response to the client's PADI (PPPoE Active Discovery Initiation) packet, the server is reconnected with the client.

As discussed above, the disadvantage of the conventional PPPoE network system is that it takes time to reconnect the client to the already-connected server, after the connection between the client and the server is improperly disconnected by the abnormality in the client's device or at the request of the user.

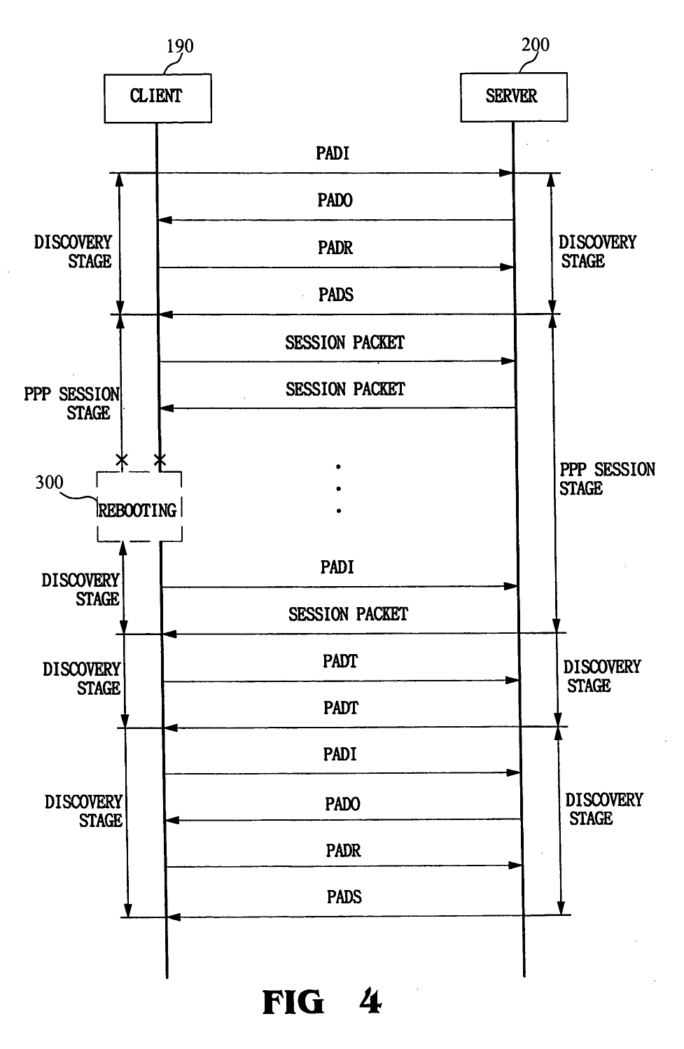

FIG. 4 is a diagram describing a reconnection method between the client 190 and the server 200 in PPPoE network system according to the present invention.

As already described with reference to FIG. 3, the client and the server are sometimes disconnected during the PPP session stage, due to the abnormality in the client's device or at the request of the user. At this time, the user reboots the device for reconnection.

With respect to FIG. 4, if the user requests reconnection by rebooting at step 300, the client 190 performs the discovery stage for connection.

The client 190 transmits the PADI (PPPoE Active Discovery initiation) packet to the server 200. However, if the server 200 is not aware of the disconnection with the client 190, the server 200 performs the PPP session stage, and transmits a session packet. Here, the session packet is either data not being transmitted to the client 190 or an Echo-Request packet.

If there is no response from the client 190 within a predetermined time, and the server 200 regards it as disconnection with the client 190, the server 200 transmits the PADO (PPPoE Active Discovery Offer) packet in response to the PADI (PPPoE Active Discovery Initiation) packet.

The client 190 then decides whether the packet from the server 200 was transmitted in the discovery stage or in the PPP session stage. If the transmitted packet is transmitted in the discovery stage, the client 190 performs the discovery stage.

On the other hand, if the transmitted packet is a packet transmitted in the PPP session stage, the client 190 extracts and stores a client MAC (Media Access Control) address and a session ID (Identifier) from the packet. The client MAC address is used for confirming whether the transmitted packet is supposed to be sent to the client itself, and the session ID is used for figuring out information about the existing session in process in the server 200.

Also, if the transmitted packet is transmitted in the PPP session stage, the client 190 performs the discovery stage in order to terminate the already- connected session. The client 190 transmits the PADT (PPPoE Active Discovery Terminate) packet to the server 200. At this time, the extracted session ID is loaded in a session ID field of the PADT (PPPoE Active Discovery Terminate) packet.

The server 200 transmits the PADT (PPPoE Active Discovery Terminate) packet to the client 190 in response to the PADT (PPPoE Active Discovery Terminate) packet from the client 190.

Accordingly, the already-connected server and the client are properly disconnected to each other, and the client 190 proceeds the discovery stage in order to reconnect with the server 200.

That is, in the reconnection method between the server 200 and the client 190 of the present invention, after the client 190 transmits the PADI (PPPoE Active Discovery Initiation) packet, when not receiving a PADO (PPPoE Active Discovery Offer) packet transmitted in the discovery stage but instead, receiving the session packet from the server 200, the client 190 performs the discovery stage for terminating the session in process in the server 200. Accordingly, the client 190 and the already-connected server 200 are properly disconnected from each other. And then, the discovery stage for reconnecting with the server 200 is performed.

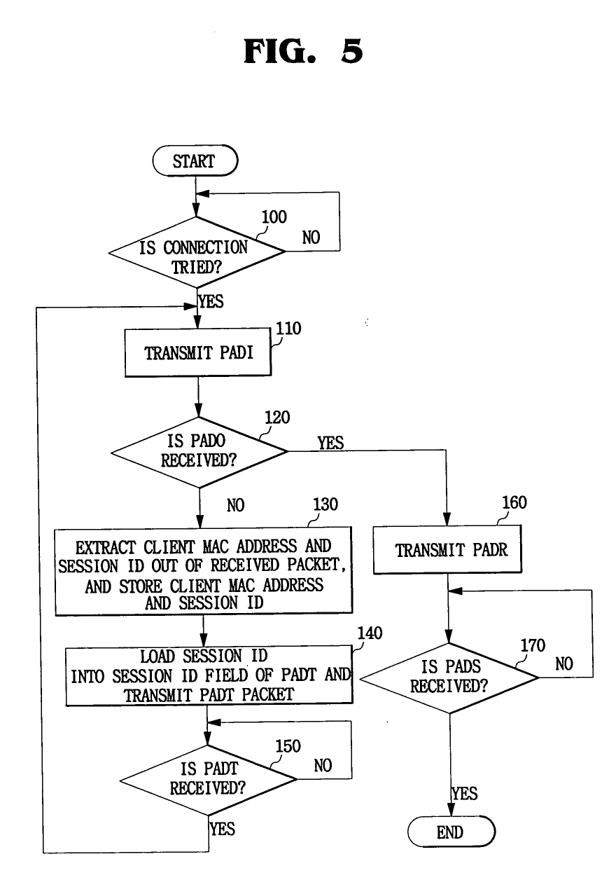

FIG. 5 is a flow chart explaining the operation of the client for connection between the client and the server in the PPPoE network system according to the present invention.

After a user boots the client's device, the client decides whether connection is tried, step 100.

If there is no connection attempt, the client returns to the step 100, but if there is a connection attempt, the client proceeds to a next step 110. The client enters the discovery stage for connection, and transmits the PADI (PPPoE Active Discovery Initiation) packet to the server, step 110.

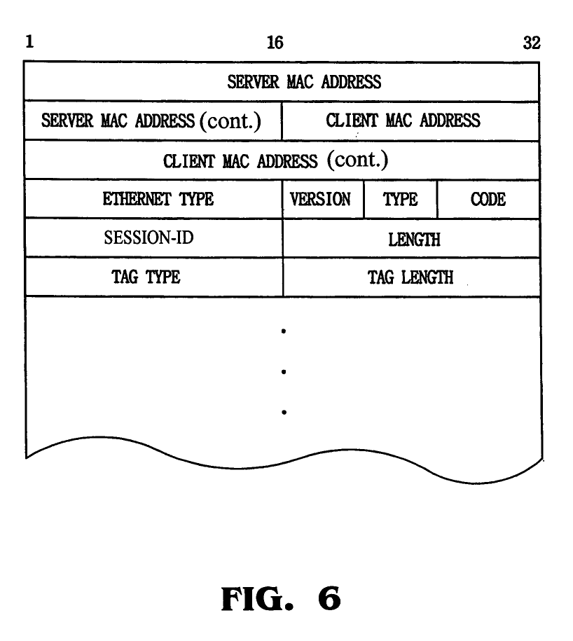

Now referring to FIG. 6, which illustrates the PADI (PPPoE Active Discovery Initiation) packet being transmitted from the client to the server, in step 110, the client, for the configuration of the PADI (PPPoE Active Discovery Initiation) packet, sets an address of a server MAC address field as a broadcast address, Oxffffffff, Oxfffff, a code of the code field as 0x09, and an ID of the session ID field as 0x0000.

Then the client decides whether the PADO (PPPoE Active Discovery Offer) packet is provided from the server, step 120.

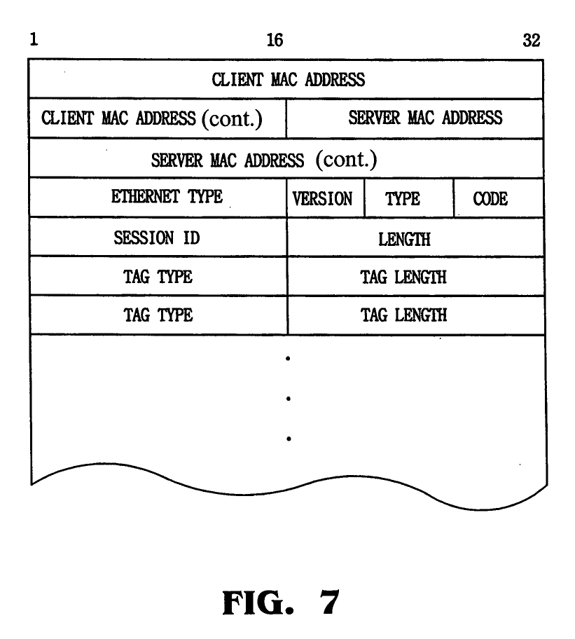

FIG. 7 illustrates a packet being transmitted from the server to the client. In step 120, the client decides whether the packet has been transmitted in the discovery stage or in the PPP session stage by detecting the data (value) of the code field.

In other words, if the data of the code field is set as 0x07, the packet is the PADO (PPPoE Active Discovery Offer). If the data of the code field is set as 0x00, however, the packet is a PPP session packet.

In step 120, if the code field of the packet is set as 0x07, the client decides the packet as the PADO (PPPoE Active Discovery Offer) packet, and if the code field of the received packet is set as 0x00, the client decides the packet as the session packet.

If the packet turns out to be the PADO (PPPoE Active Discovery Offer) packet, the client proceeds to step 160. Meanwhile, if the packet turns out to be a session packet, the client proceeds to a step 130.

In step 130, the client extracts and stores the client MAC address out of the client MAC address field of the session packet illustrated in FIG. 7 and the session ID out of the session ID field.

After the client extracts the client MAC address from the client MAC address field of the session packet, it confirms whether the transmitted session packet from the server is a packet corresponding to the client. Further, the client extracts and stores the session ID from the session ID field having information about the session currently in process.

Alternatively, at this time, it does not matter if the client does not extract the client MAC address from the client MAC address field of the session packet, but instead extracts only the session ID of the session ID field. In other words, it is not absolutely required to extract and confirm the client MAC address of the client MAC address field in the session packet.

The client loads the session ID being stored in step 130 into the session ID field of the PADT (PPPoE Active Discovery Terminate) packet, and transmits the PADT (PPPoE Active Discovery Terminate) packet, step 140.

In step 140, the reason why the client loads the session ID being stored in step 130 into the session ID field of the PADT (PPPoE Active Discovery Terminate) packet and transmits the PADT (PPPoE Active Discovery Terminate) packet is to terminate the session stage currently in process by the server, that session having been abnormally ended by the client.

That is, in steps 130 and 140, the client recognizes that the server continues to perform the PPP session. Hence, the client performs the discovery stage for terminating the connection to terminate the session currently in process by the server.

Later, the client decides whether the PADT (PPPoE Active Discovery Terminate) packet is received from the server, step 150.

If the PADT (PPPoE Active Discovery Terminate) packet is not received, the client returns to the step 150. In the meantime, if the PADT (PPPoE Active Discovery Terminate) packet is received, the client returns to the step 110 and performs the discovery stage for connection.

If the PADO (PPPoE Active Discovery Offer) packet is received in the step 120, the client transmits the PADR (PPPoE Active Discovery Request) packet in response to the PADO (PPPoE Active Discovery Offer) packet, step 160.

Lastly, the client decides whether the PADS (PPPoE Active Discovery Session-confirmation) packet is received at step 170. If the PADS (PPPoE Active Discovery Session-confirmation) packet is received in the step 170, the client terminates the discovery stage for connection and moves into the PPP session stage. However, if the PADS (PPPoE Active Discovery Session-confirmation) packet is not received, the client returns to the step 170.

According to the connection method in PPPoE network system of the present invention, when the connection between the client and the server is not properly terminated due to the abnormality in the client's device or at the request of the user, the connection between the client and the server can be reestablished. This becomes possible when the connection between the client and the server is properly terminated, that is, the client makes a reconnection attempt and transmits the PADI (PPPoE Active Discovery Initiation) packet, and if the packet from the server is not the PADO (PPPoE Active Discovery Offer) packet, the client transmits the PADT (PPPoE Active Discovery Terminate) packet to the server and receives the PADT (PPPoE Active Discovery Terminate) packet from the server.

In conclusion, the PPPoE network system and connection method according to the present invention can be established the connection between the client and the server faster and more effectively, even when the disconnection between the client and the server is caused by some errors on the client side.

While the present invention has been particularly shown and described with reference to exemplary embodiments thereof, it will be understood by those skilled in the art that the foregoing and other changes in form and details may be made therein without departing from the spirit and scope of the present invention.

1. A PPPoE (Point-to-Point Protocol over Ethernet) network system, comprising:
a client connected to a server through an Ethernet line;
said client transmitting a PADI (PPPoE Active Discovery Initiation) packet to said server if said client becomes disconnected from said server in a manner other than by transmission of PADT (PPPoE Active Discovery Terminate) packets between said client and said server;
said client checking a packet received from said server, following the transmission of said PADI (PPPoE Active Discovery Initiation) packet, to determine whether the packet received from said server was a PADO (PPPoE Active Discovery Offer) packet;
said client extracting a session-ID from said packet received from said server when it is determined that the packet received from said server is not the PADO (PPPoE Active Discovery Offer) packet;
said client loading said session-ID into a Session-ID field of a PADT (PPPoE Active Discovery Terminate) packet and transmitting the PADT (PPPoE Active Discovery Terminate) packet to said server and checking for a server transmitted PADT (PPPoE Active Discovery Terminate) packet in response thereto; and
said client transmitting a new PADI (PPPoE Active Discovery Initiation) packet to said server to reconnect said server and said client, when said client receives the server transmitted PADT (PPPoE Active Discovery Terminate) packet.

2. The system as set forth in claim 1, wherein said client checks a value of a Code field in said packet received from said server, when checking whether the packet received from said server is the PADO (PPPoE Active Discovery Offer) packet.

3. The system as set forth in claim 1, further comprising:
said client transmitting a PADR (PPPoE Active Discovery Request) packet to said server when the client determines that the packet received from said server is the PADO (PPPoE Active Discovery Offer) packet and checking for a server transmitted PADS (PPPoE Active Discovery Session-confirmation) packet in response thereto; and
said client and said server beginning a PPP (Point-to-Point Protocol) session stage when the client receives the server transmitted PADS (PPPoE Active Discovery Session-confirmation) packet.

4. The system as set forth in claim 3, wherein said client checks a value of a Code field in said packet received from said server, when checking whether the packet received from said server is the PADO (PPPoE Active Discovery Offer) packet.

5. The system as set forth in claim 1, further comprising:
said client also extracting a client MAC (Media Access Control) address from said packet received from said server when it is determined that the packet received from said server is not the PADO (PPPoE Active Discovery Offer) packet and storing the client MAC (Media Access Control) address and session-ID in memory; and
said client loading said client MAC (Media Access Control) address as well as said session-ID into the Session-ID field of the PADT (PPPoE Active Discovery Terminate) packet being transmitted to said server.

6. A method of establishing reconnection between a client and a server in PPPoE (Point-to-Point Protocol over Ethernet) network system, said method comprising steps of:
transmitting a PADI (PPPoE Active Discovery Initiation) packet from said client to said server if said client becomes disconnected from said server in a manner other than by transmission of PADT (PPPoE Active Discovery Terminate) packets between said client and said server;
checking a next packet received from said server, following the transmission of said PADI (PPPoE Active Discovery Initiation) packet, to determine whether the next packet received from said server is a PADO (PPPoE Active Discovery Offer) packet;
extracting a session-ID from said packet received from said server when it is determined that the packet received from said server is not the PADO (PPPoE Active Discovery Offer) packet;
loading said session-ID into a Session-ID field of a PADT (PPPoE Active Discovery Terminate) packet and transmitting the PADT (PPPoE Active Discovery Terminate) packet to said server;
checking for reception of a server transmitted PADT (PPPoE Active Discovery Terminate) packet; and
transmitting a new PADI (PPPoE Active Discovery Initiation) packet to said server to reconnect said server and said client, when said client receives the server transmitted PADT (PPPoE Active Discovery Terminate) packet.

7. The method as set forth in claim 6, further comprising steps of:
transmitting a PADR (PPPoE Active Discovery Request) packet to said server, when it is determined that the next packet received from said server after transmitting the PADI (PPPoE Active Discovery Initiation) packet to said server, is the PADO (PPPoE Active Discovery Offer) packet
checking for reception of a server transmitted PADS (PPPoE Active Discovery Session-confirmation) packet in response to the PADR (PPPoE Active Discovery Request) packet; and
when the client receives the server transmitted PADS (PPPoE Active Discovery Session-confirmation) packet, beginning a PPP (Point-to-Point Protocol) session stage between said client and said server.

8. The method as set forth in claim 6, said step of checking a next packet received from said server to determine whether the next packet received from said server is a PADO (PPPoE Active Discovery Offer) packet comprises checking a Code field of the next packet received from said server for a predetermined code.

9. The method as set forth in claim 7, said step of checking a next packet received from said server to determine whether the next packet received from said server is a PADO (PPPoE Active Discovery Offer) packet comprises checking a Code field of the next packet received from said server for a predetermined code.

10. The method as set forth in claim 6, further comprising:
extracting a client MAC (Media Access Control) address from said packet received from said server when it is determined that the packet received from said server is not the PADO (PPPoE Active Discovery Offer) packet and storing the client MAC (Media Access Control) address and session-ID in memory; and
loading said client MAC (Media Access Control) address as well as said session-ID into the Session-ID field of the PADT (PPPoE Active Discovery Terminate) packet being transmitted to said server.

11. A method of establishing reconnection between a client and a server in PPPoE (Point-to-Point Protocol over Ethernet) network system, said method comprising steps of:
transmitting a discovery stage initiation packet from said client to said server if said client becomes disconnected from said server in an abnormal manner during a session stage of operation between said client and said server;
checking a Code field of a next packet received from said server to determine whether the received packet is a discovery stage offer packet;
transmitting a discovery stage request packet to said server, when it is determined that the next packet received from said server was the discovery stage offer packet
checking for reception of a server transmitted discovery stage confirmation packet in response to the discovery stage request packet; and
upon reception of the server transmitted discovery stage confirmation packet, beginning a new session stage between said client and said server.

12. The method as set forth in claim 11, further comprising steps of:
extracting a session-ID from said received packet, when it is determined that the packet received from said server is not the discovery stage offer packet;
loading said session-ID into a Session-ID field of a discovery stage terminate packet and transmitting the discovery stage terminate packet to said server;
checking for reception of a server transmitted discovery stage terminate packet; and
transmitting a new discovery stage initiation packet to said server to reconnect said server and said client, when said client receives the server transmitted discovery stage terminate packet.

13. The method as set forth in claim 11, said step of checking the Code field checks for a predetermined value of 0x07 in said Code field.

14. The method as set forth in claim 12, said step of checking the Code field checks for a predetermined value of 0x07 in said Code field.

15. The method as set forth in claim 12, further comprising:
extracting a client MAC (Media Access Control) address from said packet received from said server when it is determined that the received packet is not the discovery stage offer packet and storing the client MAC (Media Access Control) address and session-ID in memory; and
loading said client MAC (Media Access Control) address as well as said session-ID into the Session-ID field of the discovery stage terminate packet being transmitted to said server.

16. The method as set forth in claim 11, wherein said abnormal manner is any manner other than by transmission of respective discovery stage terminate packets between said client and said server.
